(19) United States
(12) Patent Application Publication
(10) Pub. No.: US 2004/0158000 A1
(43) Pub. Date: Aug. 12, 2004

(54) Polypropylene resin composition

(75) Inventors: Ayako Yada, Sodegaura-shi (JP); Hiroyuki Tanimura, Sodegaura-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/661,488

(22) Filed: Sep. 15, 2003

(30) Foreign Application Priority Data
Feb. 10, 2003 (JP) 2003-032029

(51) Int. Cl. C08L 23/00

(52) U.S. Cl. 525/240

(57) ABSTRACT

There is provided a polypropylene resin composition comprising the following components (A) and (B):

(A) 10 to 99% by weight of a propylene homopolymer produced by polymerization with a metallocene catalyst, which homopolymer satisfies the following requirements (a1) and (a2):

(a1) its melting peak exists between 120° C. and 170° C. according to a differential scanning calorimetry (DSC), and

(a2) its intrinsic viscosity [η] is 0.5 to 6 dl/g, and

(B) 90 to 1% by weight of an amorphous α-olefin polymer containing not less than 20% by mol of an α-olefin unit having 3 to 20 carbon atoms, which α-olefin polymer satisfies the following requirements (b1) to (b3):

(b1) its melting peak does not exist substantially according to a differential scanning calorimetry (DSC),

(b2) its intrinsic viscosity [η] is 0.1 to 10 dl/g, and

(b3) its molecular weight distribution is not more than 4,

wherein a total of the components (A) and (B) is 100% by weight, and a total of all units contained in the amorphous α-olefin polymer is 100% by mol.

### FIELD OF THE INVENTION

The present invention relates to a polypropylene resin composition.

### BACKGROUND OF THE INVENTION

A crystalline polypropylene resin-made wrapping or packaging material such as film and sheet, and said resin-made containing material such as a blow molding bottle are required to have transparency as well as heat resistance. Therefore, a copolymer such as a crystalline propylene-ethylene random copolymer, which has lower crystallinity than a crystalline propylene homopolymer, has been used for the above-mentioned materials. However, said crystalline propylene-ethylene random copolymer does not have sufficiently satisfactory heat resistance, because said random copolymer has a lower melting point than that of the crystalline propylene homopolymer.

Under these circumstances, as a polypropylene material having both heat resistance and low crystallinity, there is proposed a polypropylene resin composition comprising a crystalline polypropylene resin and an amorphous polypropylene resin (for example, JP-A-9-309982).

However, a molded article comprising said polypropylene resin composition does not have sufficiently satisfactory bleeding resistance, because said molded article has a bleeding material on its surface when keeping it for a long time or at high temperature, and as a result, its surface becomes sticky, and its transparency deteriorates.

### SUMMARY OF THE INVENTION

An object of the present invention is to provide a polypropylene resin composition having excellent transparency, heat resistance and bleeding resistance.

The present invention is a polypropylene resin composition comprising the following components (A) and (B):

(A) 10 to 99% by weight of a propylene homopolymer produced by polymerization with a metallocene catalyst, which homopolymer satisfies the following requirements (a1) and (a2):

(a1) its melting peak exists between 120° C. and 170° C. according to a differential scanning calorimetry (DSC), and

(a2) its intrinsic viscosity [η] is 0.5 to 6 dl/g, and

(B) 90 to 1% by weight of an amorphous α-olefin polymer containing not less than 20% by mol of an α-olefin unit having 3 to 20 carbon atoms, which α-olefin polymer satisfies the following requirements (b1) to (b3):

(b1) its melting peak does not exist substantially according to a differential scanning calorimetry (DSC),

(b2) its intrinsic viscosity [η] is 0.1 to 10 dl/g, and

(b3) its molecular weight distribution is not more than 4,

wherein a total of the components (A) and (B) is 100% by weight, and a total of all units contained in the amorphous α-olefin polymer is 100% by mol.

In the present invention, a monomer unit such as the above-mentioned α-olefin unit means a unit of a polymerized monomer such as a unit of a polymerized α-olefin.

### DETAILED DESCRIPTION OF THE INVENTION

The component (A) in the present invention is a propylene homopolymer, which can be produced by polymerizing propylene with a metallocene catalyst known in the art. Examples of the metallocene catalyst are those disclosed in JP-A-58-19309, JP-A-60-35005, JP-A-60-35006, JP-A-60-35007, JP-A-60-35008, JP-A-61-130314, JP-A-3-163088, JP-A-4-268307, JP-A-9-12790, JP-A-9-87313, JP-A-10-508055, JP-A-11-80233and JP-W-10-508055. Among them, preferable is a metallocene complex, wherein two mono-, di- or tri-substituted η⁵-cyclopentadienyl groups are cross linked, and particularly preferable is a metallocene complex disclosed in JP Patent No. 2587251, JP Patent No. 2627669 and JP Patent No. 2668732.

Said propylene homopolymer can be produced by a liquid phase polymerization method such as a suspension polymerization method and a solution polymerization method, or a gas phase polymerization method.

The temperature mentioned in the above-mentioned requirement (a1) is preferably 150 to 170° C. When said requirement is not satisfied, the obtained resin composition may have inferior heat resistance and bleeding resistance.

The intrinsic viscosity [η] measured in tetralin at 135° C. mentioned in the above-mentioned requirement (a2) is preferably 0.7 to 5 dl/g. When said requirement is not satisfied, the obtained resin composition may have inferior transparency.

An isotactic pentad fraction of said propylene homopolymer is preferably not less than 0.95, more preferably 0.95 to 1, and further preferably 0.96 to 1 in order to improve bleeding resistance of the obtained resin composition. Said isotactic pentad fraction is a value obtained by calculating a formula, isotactic pentad fraction=[mmmm peak strength/total peak strength in a methyl region], according to an assignment of A. Zambelli et al in a ¹³C—NMR spectrum (Macromolecules, 8, 687 (1975)).

A cold-xylene soluble portion (CXS) at 20° C. of the propylene homopolymer is preferably not more than 0.9% by weight, and more preferably more than 0.5% by weight in order to improve bleeding resistance of the obtained resin composition, wherein the propylene homopolymer is 100% by weight.

A content of an α-olefin unit having 3 to 20 carbon atoms contained in the amorphous α-olefin polymer of the above-mentioned component (B) is not less than 20% by mol, and preferably not less than 30 by mol, wherein a total of all units contained in said amorphous α-olefin polymer is 100% by mol.

Examples of the α-olefin in the component (B) are a linear α-olefin such as propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nanodecene and 1-eicocene; and a branched α-olefin such as 3-methyl-1-butene, 3-methyl-1-pentene, 4-methyl-1-pentene, 2-ethyl-1-hexene and 2,2,4-trimethyl-1-pentene; and a combination of two or more thereof.

The amorphous α-olefin polymer may contain other monomer unit than the α-olefin unit. Examples of the other monomer are ethylene, a polyene compound, a cyclic olefin compound and a vinyl aromatic compound. A content of said other monomer unit is preferably not more than 70% by mol, wherein a total of all units contained in the amorphous α-olefin polymer is 100% by mol.

Examples of the above-mentioned polyene compound are a conjugated polyene compound and a non-conjugated polyene compound. Examples of said conjugated polyene compound are an aliphatic conjugated polyene compound and an alicyclic conjugated polyene compound. Examples of said non-conjugated polyene compound are an aliphatic non-conjugated polyene compound and an alicyclic non-conjugated polyene compound and an aromatic non-conjugated polyene compound. The polyene compound may contain a group such as an alkoxy group, an aryl group, an aryloxy group, an aralkyl group and an aralkyloxy group.

Examples of the above-mentioned cyclic olefin compound are norbornene, 5-methylnorbornene, 5-ethylnorbornene, 5-propylnorbornene, 5,6-dimethylnorbornene, 1-methylnorbornene, 7-methylnorbornene, 5,5,6-trimethylnorbornene, 5-phenylnorbornene, 5-benzylnorbornene, 5-ethylidenenorbornene, 5-vinylnorbornene, 1,4,5,8-dimethano-1,2,3,4,4a,5,8,8a-octahydronaphthalene, 2-methyl-1,4,5,8-dimethano-1,2,3,4,4a,5,8,8a-octahydronaphthalene, 2-ethyl-1,4,5,8-dimethano-1,2,3,4,4a,5,8,8a-octahydronaphthalene, 2,3-dimethyl-1,4,5,8-dimethano-1,2,3,4,4a,5,8,8a-octahydronaphthalene, 2-hexyl-1,4,5,8-dimethano-1,2,3,4,4a,5,8,8a-octahydronaphthalene, 2-ethylidene-1,4,5,8-dimethano-1,2,3,4,4a,5,8,8a-octahydronaphthalene, 2-fluoro-1,4,5,8-dimethano-1,2,3,4,4a,5,8,8a-octahydronaphthalene, 1,5-dimethyl-1,4,5,8-dimethano-1,2,3,4,4a,5,8,8a-octahydronaphthalene, 2-cyclohexyl-1,4,5,8-dimethano-1,2,3,4,4a,5,8,8a-octahydronaphthalene, 2,3-dichloro-1,4,5,8-dimethano-1,2,3,4,4a,5,8,8a-octahydronaphthalene, 2-isobutyl-1,4,5,8-dimethano-1,2,3,4,4a,5,8,8a-octahydronaphthalene, 1,2-dihydrodicyclopentadiene, 5-chloronorbornene, 5,5-dichloronorbornene, 5-fluoronorbornene, 5,5,6-trifluoro-6-trifluoromethylnorbornene, 5-chloromethylnorbornene, 5-methoxynorbornene, 5,6-dicarboxylnorbornene anhydride, 5-dimethylaminonorbornene, 5-cyanonorbornene, cyclopentene, 3-methylcyclopentene, 4-methylcyclopentene, 3,4-dimethylcyclopentene, 3,5-dimethylcyclopentene, 3-chlorocyclopentene, cyclohexene, 3-methylcyclohexene, 4-methylcyclohexene, 3,4-dimethylcyclohexene, 3-chlorocyclohexene and cycloheptene.

Examples of the above-mentioned vinyl aromatic compound are styrene, α-methylstyrene, p-methylstyrene, vinylxylene, monochlorostyrene, dichlorostyrene, monobromostyrene, dibromostyrene, fluorostyrene, p-tert-butylstyrene, ethylstyrene and vinylnaphthalene.

The amorphous α-olefin polymer is preferably a propylene homopolymer, a propylene-ethylene copolymer, a copolymer of propylene and an α-olefin other than propylene, or a copolymer of ethylene, propylene and an α-olefin other than propylene; more preferably a propylene homopolymer, a propylene-ethylene copolymer, a propylene-1-butene copolymer, a propylene-1-hexene copolymer, a propylene-ethylene-1-butene copolymer, or a propylene-ethylene-1-hexene copolymer; further preferably a propylene-1-butene copolymer or a propylene-ethylene-1-butene copolymer; and most preferably a propylene-1-butene copolymer. These polymers may be used singly or in combination thereof.

When the requirement (b1) is not satisfied, the obtained resin composition may have inferior transparency.

The intrinsic viscosity [η] measured in tetralin 135° C. mentioned in the requirement (b2) is preferably 0.3 to 7 dl/g. When said requirement is not satisfied, the obtained resin composition may have inferior transparency.

The molecular weight distribution mentioned in the requirement (b3) is not more than 4, preferably 1 to 4, and more preferably 1 to 3. When said molecular weight distribution exceeds 4, the obtained resin composition may have inferior bleeding resistance. Said molecular weight distribution means a ratio of a weight average molecular weight (Mw) to a number average molecular weight (Mn), namely, Mw/Mn, which is measured by a gel permeation chromatography (GPC) wherein a standard polystyrene is used as a molecular weight standard reference material.

The amorphous α-olefin polymer can be produced by a slurry polymerization method, a solution polymerization method, a bulk polymerization method or a gas phase polymerization method with a metallocene catalyst known in the art. Examples of the metallocene catalyst are those disclosed in the above-mentioned patent literatures. A particularly preferable method for producing the amorphous α-olefin polymer using a metallocene catalyst is disclosed in EP-A-1211287.

A content of a propylene unit contained in the amorphous α-olefin polymer is preferably not less than 30% by mol, more preferably not less than 50% by mol, and further preferably not less than 80% by mol, wherein a total of all units contained in said α-olefin polymer is 100% by mol, in order to improve transparency and heat resistance of the obtained resin composition.

A content of the component (A) contained in the polypropylene resin composition in accordance with the present invention is 10 to 99% by weight, and preferably 20 to 95% by weight; and a content of the component (B) contained therein is 90 to 1% by weight, and preferably 80 to 5% by weight, wherein a total of the components (A) and (B) is 100% by weight. When said content of the component (A) is less than 10% by weight, the obtained resin composition may have inferior heat resistance and bleeding resistance. When said content thereof exceeds 99% by weight, the obtained resin composition may have inferior transparency.

Respective components used in the present invention can be used in combination with other components, for example, stabilizers known in the art such as crystal nucleating agents, transparency agents, heat stabilizers, ultraviolet stabilizers, ultraviolet absorbers, antiozonants, weatherability stabilizers, foaming agents, antifogging agents, rust inhibiting agents, ion trapping agents, fire retardants, fire co-retardants, inorganic fillers, age resisters and light stabilizers; and additives such as antistatic agents, slipping agents, internal peeling agents, coloring agents, dispersants, anti-blocking agents, lubricants, anti-bacterium agents, petroleum resins, foaming agents, foaming co-agents, high frequency processing agents, organic pigments and inorganic pigments.

The resin composition in accordance with the present invention can be produced by a method known in the art. Examples thereof are (1) a method of blending respective components in an apparatus such as a Henschel mixer, a V-blender, a ribbon blender and a tumbler blender; and (2) a method comprising the steps of (i) blending respective components as mentioned above to produce a blend, (ii) melt-kneading the blend in an apparatus such as a single-screw extruder, a twin-screw extruder, a kneader and a Banbury mixer to produce a kneaded product, and then (iii) pelletizing or pulverizing the kneaded product.

The resin composition in accordance with the present invention can be molded to articles having various shapes such as film, sheet and containers, by various molding methods known in the art. Examples of the molding methods are an injection molding method, a compression molding method, an injection compression molding method, a T-die film forming method, a stretch film forming method, an inflation film forming method, a sheet forming method, a bank molding method, a calender molding method, a pressure forming method, a vacuum forming method, a pipe forming method, a profile extrusion molding method, a blow molding method, an injection blow molding method, an injection stretch blow molding method and a lamination molding method.

Said molded articles can be applied to, for example, automobile parts, bicycle parts, electric and electronic instrument parts, electric wires, building materials, necessities for agricultural, marine or horticultural use, necessities for chemical industrial use, materials for engineering use, materials for commercial or industrial use, furniture, writing materials, necessities for dairy or miscellaneous use, clothes, containers and necessities for wrapping use, tools, necessities for leisure use and necessities for medical use.

The above-mentioned vehicle parts include, for example, car interior skins such as instrumental panels, doors, pillars and air bag covers; car exterior parts such as over-fenders, clouding panels, roof rails and side mauls; hoses; tubes; gaskets; packing; weather strips; seal sponges of every kind; drain tubes for washing liquid; cushioning materials for a fuel tank; and bicycle parts.

The above-mentioned electric and electronic instrument parts include, for example, electric machine parts, electronic parts, weak electric parts, home electric parts, necessities for refrigerators; illumination instruments; and electric covers.

The above-mentioned electric wires include, for example, plastic cables, insulation wires and wire-protecting materials.

The above-mentioned building materials include, for example, those used for walls and ceilings such as ribs, baseboards, panels and tarpaulins; those used for roofs such as corrugated sheets, conduits and materials for roof foundation use; those used for floors such as materials for threshold use and tiles; those used for waterproofing such as pointing, pointing rods and waterproofing sheet, those used for accommodations and apparatus parts such as ducts, cable ducts, prefab materials and septic tanks; those used for structures and fixtures such as building edges, building gaskets, carpet holders, angles and louvers; and those used for industrial materials such as joiners and curing sheets.

The above-mentioned necessities for agricultural, marine or horticultural use include, for example, those used for agricultural hoses.

The above-mentioned materials for commercial or industrial use include, for example, machine covers, machine parts, packing, gaskets, flanges, leather duck, bolts, nuts, valves, metal-protecting films and convexo-concave hoses.

The above-mentioned furniture includes, for example, cabinets, stools, sofas, mats, curtains and table clothes.

The above-mentioned writing materials include, for example, card cases, pencil cases, accessories, key cases, cashing card cases, stickers, labels, book covers, notebook covers, binders, notebooks, covers, files, cards, commutation tickets, pads, holders, magazine trays, albums, templates and pen holders.

The above-mentioned necessities for dairy or miscellaneous use include, for example, bath lids, drainboards, buckets, dress covers, bedding covers, umbrellas, umbrella covers, reed screens, sewing requisites, shelf boards, shelf supports, tablets, aprons, trays, tapes, cords, belts and bags.

The above-mentioned clothes include, for example, rain coats, mackintoshes, rain gear sheets, leather coats for children, shoes, shoes covers, footwear, globes, skiwear, hats and supplemental materials for hats.

The above-mentioned containers and necessities for wrapping use include, for example, food containers, goods used for packing clothes, wrapping and packing materials, bottles for cosmetics, containers for cosmetics, vials for medicines, bottles for foods, bottles for physics and chemistry, bottles for detergents, containers, caps, hood packs, laminate films, industrial shrinking films and wrapping films for business use.

The above-mentioned necessities for medical use include, for example, liquid transport bags, continuously portable bags for peritoneal dialysis and blood-bags.

### EXAMPLE

The present invention is explained with reference to the following Examples, which do not limit the scope of the present invention.

Properties were measure according to the following methods.

1. 20° C. Xylene-Soluble Portion (CXS (wt %))

It was measured by a method comprising the steps of:

(1) dissolving 1 g of a sample in 100 ml of boiled xylene to obtain a solution,

(2) cooling the solution to 20° C.,

(3) allowing the solution to stand at 20° C. for 4 hours to precipitate a material,

(4) separating the material by filtration to obtain a filtrate,

(5) drying up the filtrate,

(6) further drying at 70° C. under vacuum to obtain a polymer,

(7) weighing the polymer (W g), and,

(8) calculating a formula, CXS=100×W/W₀, to obtain CXS (wt %), wherein W₀ is the weight (g) of the sample originally used.

2. Content of Respective Monomer Units Contained in Amorphous α-olefin Polymer

A ratio of a propylene unit to a1-butene unit was calculated from a ratio of spectrum strength of a methyl carbon contained in the propylene unit to that of a methyl carbon contained in the 1-butene unit in a ¹³C—NMR spectrum, which spectrum was obtained using an NMR equipment, a trade name of AC-250, manufactured by Bruker.

3. Melting Point (Tm (°C.))

It was measured by a method comprising the steps of:

(1) heating a sample from room temperature to 200° C. at a temperature-raising rate of 30° C./minute,

(2) keeping the sample at 200° C. for 5 minutes,

(3) cooling the sample from 200° C. to −100° C. at a temperature-lowering rate of 10° C./minute,

(4) keeping the sample at −100° C. for 5 minutes, and

(5) measuring a endothermic curve according to JIS K7121 using a differential scanning calorimeter (DSC) under raising temperature from −100° C. to 200° C. at a temperature-lowering rate of 10° C./minute, wherein a melting point at a maximum temperature was assigned to a melting point (Tm) in case of existence of plural melting peaks.

4. Intrinsic Viscosity [η] (dl/g)

It was measured according to a method comprising the steps of:

(1) preparing three kinds of tetralin solutions of a polymer having respective concentrations (c) of 0.6, 1.0 and 1.5 mg-polymer/ml-tetralin,

(2) measuring a specific viscosity (ηₛₚ) of each of said solutions three times at 135° C. using an Ubbelohde viscometer,

(3) averaging the obtained three specific viscosity (ηₛₚ) values, respectively,

(4) making a graph indicating a relationship between the concentration (c) and the average specific viscosity (ηₛₚ), and

(5) assigning a viscosity at C=0 to an intrinsic viscosity [η].

5. Molecular Weight Distribution (Mw/Mn)

Using a solution of about 5 mg of a sample in 5 ml of o-dichlorobenzene, it was measured according to a gel permeation chromatography (GPC) under conditions as mentioned:

(i) an apparatus, a trademark of 150C/GPC, manufactured by Waters Co., was used as a GPC apparatus,

(ii) a column, a trademark of SODEX PACKED COLUMN A-80M, manufactured by Showa Denko K.K. was used as a column,

(iii) 400 micro-litters of the above-mentioned solution was injected,

(iv) an elution temperature was adjusted to 140° C.,

(v) a flow rate of the solution eluted was controlled to 1.0 ml/min,

(vi) a refractivity detector was used as a detector,

(vii) polystyrene having molecular weights between 68-8,400,000, manufactured by Tosoh Corporation was used as a molecular weight standard reference material, and

(viii) a molecular weight distribution (Mw/Mn) was calculated based on a weight average molecular weight (Mw) and a number average molecular weight (Mn) of the sample, each of which average molecular weights was obtained by converting to the molecular weight of the above-mentioned polystyrene.

6. Isotactic Pentad Fraction

It was obtained by calculating a formula, isotactic pentad fraction=[mmmm peak strength/total peak strength in a methyl region], according to an assignment of A. Zambelli et al in a ¹³C—NMR spectrum (Macromolecules, 8, 687 (1975)).

7. Heat Resistance

It was evaluated from a melting point measured according to JIS K7121 based on the following criteria:

(1) X which means that the melting point was less than 150° C.,

(2) Δ which means that the melting point was not less than 150° C. to less than 160° C., and

(3) ◯ which means that the melting point was not less than 160° C.

8. Transparency

It was measured by a method comprising the steps of:

(1) preparing a 1 mm-thick sheet by press-molding a sample at 230° C. according to JIS K7151, and

(2) measuring haze (Haze-1) of the sheet according to JIS K7105.

9. Bleed Resistance

It was measured by a method comprising the steps of:

(1) heat-treating the above-mentioned transparency-evaluated sheet at 60° C. for 24 hours,

(2) measuring haze (Haze-2) of the heat-treated sheet according to JIS K7105, and

(3) calculating a difference (Δ Haze) between Haze-1 and Haze-2, namely, Δ Haze=Haze-2−Haze-1, wherein the smaller the difference (Δ Haze) is, the better the bleed resistance is.

Further, feeling of a surface of the heat-treated sheet was evaluated based on the following criteria, wherein the smaller stickiness is, the better the bleed resistance is:

(1) ◯ which means that stickiness was not observed completely,

(2) Δ which means that that stickiness was observed slightly, and

(3) X which means that more stickiness was observed.

### EXAMPLE 1

### 1. Production of Propylene Homopolymer

1.3 Milliliter of a toluene solution of triisobutylaluminum having a concentration of 1 mmol/ml, and 0.65 ml of a toluene solution of dimethylsilylbis(2-methyl-1-indenyl)zirconium dichloride having a concentration of 2 μmol/ml were contacted, and the resulting contacted product was added to an autoclave.

Next, a solution of 1.2 mg of triphenylmethyltetraxis(pentafluorophenyl) borate in 0.58 ml of toluene was added thereto. Then, propylene was fed continuously, and was polymerized at 40° C. under keeping a total pressure at 0.6 MPa.

After 60 minutes from the beginning of the above-mentioned feed of propylene, 20 ml of isobutanol was added thereto to terminate the polymerization, and propylene remaining not-polymerized was purged.

A produced powder was dried under vacuum at 60α C. for 5 hours to obtain 140 g of a propylene homopolymer (referred to as “polymer A \mathring{1}”, hereinafter). Its melting point, intrinsic viscosity [η], molecular weight distribution (Mw/Mn), isotactic pentad fraction, and 20° C. xylene-soluble portion (CXS) were 161° C., 1.9 dl/g, 2.2, 0.964 and 0.1% by weight, respectively. Properties of the polymer A \mathring{1} are sown in. Table 1.

### 2. Production of Amorphous α-olefin Polymer

A propylene-1-butene copolymer (referred to as “polymer B \mathring{1}”, hereinafter) corresponding to the component (B) in the present invention was obtained by copolymerizing continuously propylene and 1-butene using hydrogen as a molecular weight regulator, in a 100 L SUS-made polymerization vessel equipped with a stirrer according to the following method.

Hexane as a polymerization solvent, propylene and 1-butene were added continuously to a lower part of the polymerization vessel at a rate of 100 L/hour, 24.00 kg/hour and 1.81 kg/our, respectively.

A reaction mixture was drawn out continuously from an upper part of the polymerization vessel keeping an amount of a reaction mixture existing therein at 100 L.

As polymerization catalyst components, dimethylsilyl (tetramethylcyclopentadienyl) (3-tert-butyl-5-methyl-2-phenoxy) titanium dichloride, triphenylmethyltetraxis(pentafluorophenyl) borate and triisobutylaluminum were added continuously from a lower part of the polymerization vessel at 0.005 g/hour, 0.298 g/hour and 2.315 g/hour, respectively.

Said copolymerization was carried out at 45° C. recycling cooled water in a jacket equipped on an outer side of the polymerization vessel.

The polymerization reaction was terminated by adding a little amount of ethanol to a reaction mixture drawn out continuously from an upper part of the polymerization vessel. Then, monomers remaining not-polymerized were purged; washing with water was carried out; and the polymerization solvent was removed by steaming in a large amount of water, thereby obtaining the polymer B \mathring{1} at a rate of 7.10 kg/hour, which was dried overnight at 80° C. under vacuum.

The polymer B \mathring{1} contained 94.5% by weight of a propylene unit, and 5.5% by weight of a 1-butene unit. Its intrinsic viscosity [η] and molecular weight distribution (Mw/Mn) were 2.3 dl/g and 2.2, respectively. Its melting point (Tm) did not exist substantially according to a differential scanning calorimetry (DSC).

### 3. Production of Resin Composition

A blend of 48 g of the polymer A \mathring{1}, 12 g of the polymer B \mathring{1}, 0.12 g of a hindered phenol antioxidant (IRGANOX 1010 produced by Ciba Specialty Chemicals) and 0.12 g of an aromatic phosphite antioxidant (IRGAFOS 168 produced by Ciba Specialty Chemicals) was kneaded in a twin-screw batch type kneading apparatus, Brabender Plasti-Corder, manufactured by Brabender OGH at 220° C. at a screw rotating speed of 100 rpm for 5 minutes to obtain a resin composiiton. Evaluation results of properties thereof are shown in Table 2.

### Comparative Example 1

Example 1 was repeated except that the polymer A \mathring{1} was changed to a propylene homopolymer (referred to as “polymer C \mathring{1}”, hereinafter, Tm=160° C. and [η]=1.9 dl/g, a trade name of NOBLEN H501N, manufactured by Sumitomo Chemical Co., Ltd.) polymerized by a Ziegler-Natta catalyst. Evaluation results of properties of the polymer C \mathring{1} are shown in Table 2.

### Comparative Example 2

Example 1 was repeated except that the polymer A \mathring{1} was changed to a propylene-ethylene copolymer (referred to as “polymer C \mathring{2}”, hereinafter, Tm=155° C., [η]=1.9 dl/g, an ethylene unit content=1.5% by weight and CXS=1.0% by weight, a trade name of NOBLEN H501, manufactured by Sumitomo Chemical Co., Ltd.) polymerized by a Ziegler-Natta catalyst. Evaluation results of properties of the polymer C \mathring{2} are shown in Table 2.

### Comparative Example 3

Example 1 was repeated except that the polymer A \mathring{1} was changed to a propylene-ethylene copolymer (referred to as “polymer C \mathring{3}”, hereinafter, Tm=138° C., [η]=1.6 dl/g, an ethylene unit content=4.6% by weight and CXS=4.7% by weight, a trade name of NOBLEN W151, manufactured by Sumitomo Chemical Co., Ltd.) polymerized by a Ziegler-Natta catalyst. Evaluation results of properties of the polymer C \mathring{3} are shown in Table 2.

TABLE 1

| Propylene polymer | A \mathring{1} | C \mathring{2} | C \mathring{2} | C \mathring{3} |
|---|---|---|---|---|
| Catalyst | Metallocene | Ziegler-Natta | | |
| Melting point (° C.) | 161 | 160 | 155 | 138 |
| Intrinsic viscosity (dl/g) | 1.9 | 1.9 | 1.9 | 1.6 |
| Isotactic pentad fraction | 0.964 | 0.970 | — | — |
| Molecular weight | 2.2 | 5.3 | 5.2 | 5.3 |
| distribution | | | | |
| CXS (% by weight) | 0.1 | 1.0 | 1.0 | 4.7 |

TABLE 2

| | Example | Comparative Example | | |
|---|---|---|---|---|
| | 1 | 1 | 2 | 3 |
| Blending ratio (% by weight) | | | | |
| A \mathring{1} | 80 | | | |
| B \mathring{1} | 20 | 20 | 20 | 20 |
| C \mathring{1} | | 80 | | |
| C \mathring{2} | | | 80 | |
| C \mathring{3} | | | | 80 |
| Property | | | | |
| Heat resistance | ◯ | ◯ | Δ | X |
| Transparency: Haze (%) | 6.3 | 8.8 | 9.1 | 4.9 |
| Bleed resistance | | | | |
| Δ Haze (%) | 1.7 | 5.0 | 5.9 | 7.3 |
| (Haze-2 after heat-treatment | (8.0) | (13.8) | (15.0) | (12.3) |
| (%)) | | | | |
| Feeling of surface | ◯ | X | X | X |

As mentioned above, the polypropylene resin composition in accordance with the present invention has excellent transparency, heat resistance and bleeding resistance.

1. A polypropylene resin composition comprising the following components (A) and (B):
(A) 10 to 99% by weight of a propylene homopolymer produced by polymerization with a metallocene catalyst, which homopolymer satisfies the following requirements (a1) and (a2):
(a1) its melting peak exists between 120° C. and 170° C. according to a differential scanning calorimetry (DSC), and
(a2) its intrinsic viscosity [η] is 0.5 to 6 dl/g, and
(B) 90 to 1% by weight of an amorphous α-olefin polymer containing not less than 20% by mol of an α-olefin unit having 3 to 20 carbon atoms, which α-olefin polymer satisfies the following requirements (b1) to (b3):
(b1) its melting peak does not exist substantially according to a differential scanning calorimetry (DSC),
(b2) its intrinsic viscosity [η] is 0.1 to 10 dl/g, and
(b3) its molecular weight distribution is not more than 4,
wherein a total of the components (A) and (B) is 100% by weight, and a total of all units contained in the amorphous α-olefin polymer is 100% by mol:

2. The polypropylene resin composition according to claim 1, wherein the component (A) has an isotactic pentad fraction of not less than 0.95.

3. The polypropylene resin composition according to claim 1 or 2, wherein the α-olefin unit in the component (B) is a propylene unit, and its content is not less than 30% by mol.
